(19) United States
(12) Patent Application Publication
(10) Pub. No.: US 2017/0099616 A1
(43) Pub. Date: Apr. 6, 2017

(54) WIRELESS COMMUNICATION DEVICE, WIRELESS COMMUNICATION SYSTEM, AND COMMUNICATION CONTROL METHOD

(71) Applicant: KYOCERA Corporation, Kyoto-shi (JP)

(72) Inventors: Fangwei TONG, Tokyo (JP); Chiharu YAMAZAKI, Tokyo (JP); Hiroyuki URABAYASHI, Yokohama-shi (JP); Katsuhiro MITSUI, Kawasaki-shi (JP)

(21) Appl. No.: 15/382,355

(22) Filed: Dec. 16, 2016

Related U.S. Application Data
(63) Continuation of application No. PCT/JP2015/065980, filed on Jun. 3, 2015.

(30) Foreign Application Priority Data
Jun. 25, 2014 (JP) 2014-130122

(51) Int. Cl. H04W 28/06; H04W 24/10; H04B 17/309

(52) U.S. Cl. CPC H04W 28/06; H04B 17/309; H04W 24/10

(57) ABSTRACT

A wireless communication device for performing communication with a controlled wireless communication device that is controlled by the wireless communication device includes a controller configured to estimate channel quality of a channel that is used in feedback of a signal from the controlled wireless communication device, dynamically adjust, on the basis of the estimated channel quality, the number of quantized bits to be used when the controlled wireless communication device quantizes channel state information, and notify the controlled wireless communication device of the dynamically adjusted number of quantized bits. The controller is also configured to adjust the number of quantized bits such that the number of quantized bits increases as the estimated channel quality improves.

### CROSS-REFERENCE TO RELATED APPLICATION

The present application is a continuation based on PCT Application No. PCT/JP2015/065980 filed on Jun. 3, 2015, which claims the benefit of Japanese Patent Application No. 2014-130122 filed on Jun. 25, 2014. PCT Application No. PCT/JP2015/065980 is entitled “WIRELESS COMMUNICATIONS DEVICE, WIRELESS COMMUNICATIONS SYSTEM, AND WIRELESS COMMUNICATIONS METHOD” and Japanese Patent Application No. 2014-130122 is entitled “WIRELESS COMMUNICATION DEVICE, WIRELESS COMMUNICATION SYSTEM, AND COMMUNICATION CONTROL METHOD”. The contents of which are incorporated by reference herein in their entirety.

### FIELD

Embodiments of the present disclosure relate generally to wireless communication devices and in particular to wireless communication devices for feeding back channel state information to base stations, using digital transmission systems.

### BACKGROUND

Digital transmission systems have become the mainstream of wireless communication in recent years. Wireless communication devices that employ digital transmission systems perform various types of signal processing such as quantization, binary coding, and symbol mapping on analog data to be transmitted, when generating transmission signals from analog values. This processing is disclosed in the 3GPP technical specification “TS36.211, V11.1.0” (December 2012).

Quantization refers to the process of replacing continuous analog values with approximate discrete values such as integers. Binary coding refers to the process of converting discrete values obtained by quantization into binary numbers (i.e., bit string). Symbol mapping refers to the process of converting (i.e., digitally modulating) a bit string obtained by binary coding into transmission symbols.

The aforementioned digital transmission systems can adopt error-correcting codes or other schemes and thus provide high resistance to noise and interference in transmission channels, but may face the problem of channel capacity shortage because the transmission bit length needs to increase in order to improve the resolution of data to be transmitted. Conversely, a short bit length that is set in consideration of channel capacity may inhibit efficient use of channel capacity and degrade resolution, despite improved channel quality and sufficient channel capacity.

In the aforementioned digital transmission systems, channel state information (CSI) measured by user terminals is fed back to base stations, and at this time the CSI is quantized with a predetermined fixed number of bits. This has the advantage of fixing quantization errors and maintaining a constant level of accuracy of the CSI. However, the accuracy of the CSI remains unchanged even in good channel conditions, and therefore an improvement in transmission performance cannot be expected.

### SUMMARY

A wireless communication device, a wireless communication system, and a communication control method are disclosed. In one embodiment, a wireless communication device according to the disclosure is a wireless communication device for performing communication with a controlled wireless communication device that is controlled by the wireless communication device. The wireless communication device includes at least one processor configured to estimate channel quality of a channel that is used in feedback of a signal from the controlled wireless communication device, dynamically adjust, on the basis of the estimated channel quality, the number of quantized bits to be used when the controlled wireless communication device quantizes channel state information, and notify the controlled wireless communication device of the dynamically adjusted number of quantized bits. The at least one processor is configured to increase the number of quantized bits as the estimated channel quality improves.

In one embodiment, a wireless communication system according to the disclosure is a wireless communication system that includes a wireless communication device, and a controlled wireless communication device that is under control of the wireless communication device. The wireless communication device includes at least one processor configured to estimate channel quality of a channel that is used in feedback of a signal from the controlled wireless communication device, dynamically adjust, on the basis of the estimated channel quality, the number of quantized bits to be used when the controlled wireless communication device quantizes channel state information, and notify the controlled wireless communication device of the dynamically adjusted number of quantized bits. The at least one processor is configured to increase the number of quantized bits as the estimated channel quality improves.

In one embodiment, a communication control method according to the disclosure is a communication control method for use in a wireless communication device for performing communication with a controlled wireless communication device that is under control of the wireless communication device. The method includes the steps of (a) estimating channel quality of a channel that is used in feedback of a signal from the controlled wireless communication device, and (b) dynamically adjusting, on the basis of the estimated channel quality, the number of quantized bits to be used when the controlled wireless communication device quantizes channel state information. The step (b) includes the step of adjusting the number of quantized bits such that the number of quantized bits increases as the estimated channel quality improves.

### BRIEF DESCRIPTION OF THE DRAWINGS

FIG. 1 illustrates a configuration of an LTE system according to an embodiment.

FIG. 2 illustrates a block diagram of a UE according to an embodiment.

FIG. 3 illustrates a block diagram of an eNB according to an embodiment.

FIG. 4 illustrates a wireless interface protocol stack in the LTE system.

FIG. 5 illustrates the structure of a radio frame used in the LTE system.

FIG. 6 illustrates a flowchart for describing the operation of controlling dynamic processing of the number of quantized bits and an MCS on the basis of an estimated value of channel quality according to an embodiment.

FIG. 7 illustrates an example of a channel matrix.

FIG. 8 illustrates a correspondence table between the channel quality and the number of quantized bits.

FIG. 9 illustrates a correspondence table between the channel quality and the MCS.

FIG. 10 illustrates an example of a joint table.

FIG. 11 illustrates a flowchart for describing Variation 1 of an embodiment.

FIG. 12 illustrates a flowchart for describing Variation 1 of an embodiment.

FIG. 13 illustrates a flowchart for describing Variation 2 of an embodiment.

FIG. 14 illustrates a flowchart for describing Variation 4 of an embodiment.

FIG. 15 illustrates a flowchart for describing a method of dynamically adjusting the interval of channel estimation.

### DETAILED DESCRIPTION

### Introduction

Prior to descriptions of embodiments of the disclosure, Long Term Evolution (LTE) standardized by the 3rd Generation Partnership Project (3GPP) will be described.

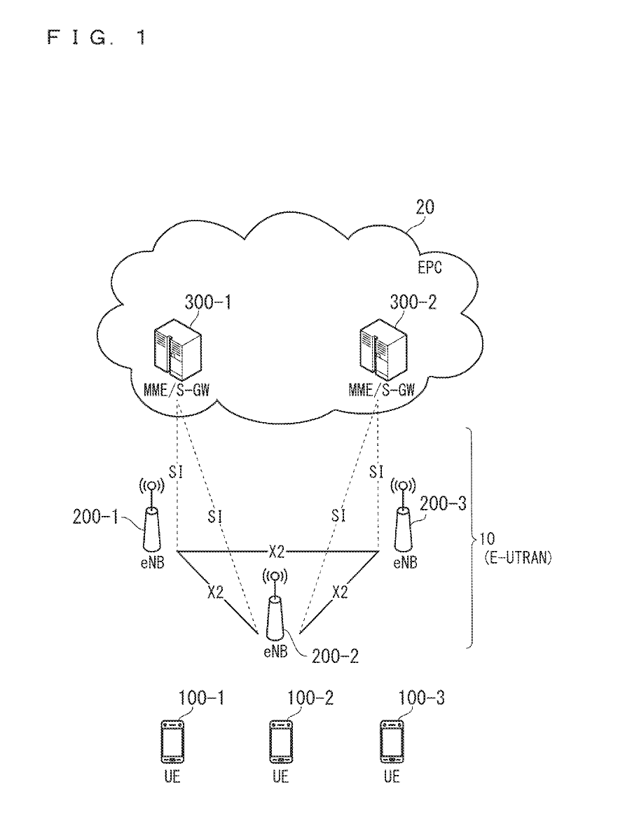

FIG. 1 illustrates a configuration of an LTE system. As illustrated in FIG. 1, the LTE system includes multiple pieces of user equipment (UEs) 100, an evolved-UMTS terrestrial radio access network (E-UTRAN) 10, and an evolved packet core (EPC) 20. The E-UTRAN 10 corresponds to a wireless access network, and the EPC 20 corresponds to a core network. The E-UTRAN 10 and the EPC 20 constitute a network of the LTE system.

The UEs 100 are mobile communication devices and can perform wireless communication with connection destination cells (serving cells). The UEs 100 correspond to user terminals.

The E-UTRAN 10 includes multiple evolved Node-Bs (eNBs) 200. The eNBs 200 correspond to base stations. Each eNB 200 can manage a single or multiple cells and perform wireless communication with UEs 100 that have connection with the cells managed by the eNB 200. The term “cell” is used not only as a term indicating the smallest unit of a wireless communication area, but also as a term indicating the function of performing wireless communication with UEs 100.

The eNBs 200 have functions such as a radio resource management (RRM) function, a user data routing function, and a measurement control function for mobility control and scheduling.

The EPC 20 includes multiple MME/S-GWs (mobility management entity/serving-gateway) 300.

The MME is a network node for controlling various types of control such as mobility control on the UEs 100, and corresponds to a control station. The S-GW is a network node for controlling the transfer of user data, and corresponds to a switching center. The EPC 20 constituted by the MME/S-GWs 300 houses the eNBs 200.

The eNBs 200 are connected to one another via interfaces X2. The eNBs 200 are also connected to the MME/S-GWs 300 via interfaces SI.

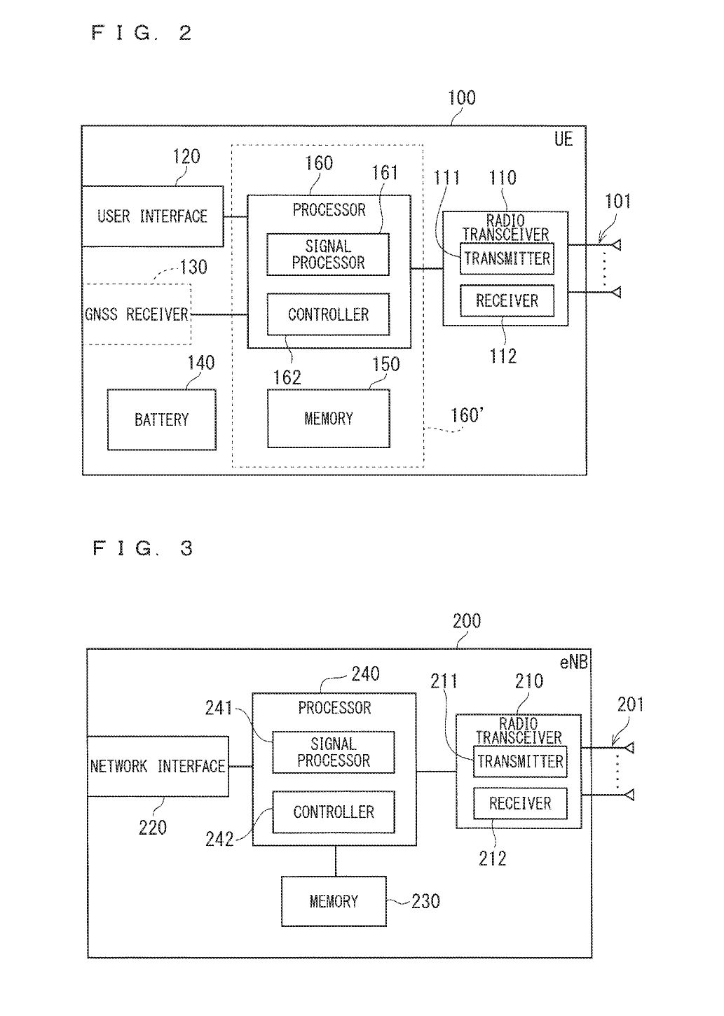

FIG. 2 illustrates a block diagram showing a configuration of a UE 100. As illustrated in FIG. 2, the UE 100 includes multiple antennas 101, a radio transceiver 110, a user interface 120, a global navigation satellite system (GNSS) receiver 130, a battery 140, a memory 150, and a processor 160. The UE 100 may not include the GNSS receiver 130. The memory 150 and the processor 160 may be integrated with each other, and this integrated set (i.e., chip set) may serve as a processor 160′.

The multiple antennas 101 and the radio transceiver 110 are used to transmit and receive radio signals. The radio transceiver 110 includes a transmitter 111 that can convert baseband signals (transmission signals) output from the processor 160 into radio signals and transmit the radio signals from the multiple antennas 101. The radio transceiver 110 also includes a receiver 112 that can convert radio signals received by the multiple antennas 101 into baseband signals (received signals) and output the baseband signals to the processor 160.

The user interface 120 is an interface with the user who holds the UE 100 and includes, for example, a display, a microphone, a speaker, and various types of buttons. The user interface 120 can accept user operation and output a signal that indicates the content of that operation to the processor 160.

The GNSS receiver 130 can receive GNSS signals and output the received signals to the processor 160 in order to obtain position information that indicates the geographical position of the UE 100. The battery 140 can store power that is supplied to each block of the UE 100.

The memory 150 can store programs to be executed by the processor 160 and information to be used in the processing performed by the processor 160. The processor 160 includes a signal processor 161 that can perform signal processing such as modulation, demodulation, encoding, and decoding of the baseband signals, and a controller 162 that can perform various types of control by executing the programs stored in the memory 150.

The signal processor 161 includes a digital transmission processor because channel state information (CSI) measured by the UE 100 is transmitted via digital feedback to an eNB 200, as will be described later.

The digital transmission processor can generate transmission signals, using a digital transmission system compliant with the current 3GPP standards.

The processor 160 may further include a codec that can encode and decode sound and video signals. The processor 160 can perform various types of control, which will be described later.

FIG. 3 illustrates a block diagram showing a configuration of an eNB 200. As illustrated in FIG. 3, the eNB 200 includes multiple antennas 201, a radio transceiver 210, a network interface 220, a memory 230, and a processor 240. The memory 230 and the processor 240 constitute a base-station controller.

The multiple antennas 201 and the radio transceiver 210 are used to transmit and receive radio signals. The radio transceiver 210 includes a transmitter 211 that can convert baseband signals (transmission signals) output from the processor 240 into radio signals and transmit the radio signals from the multiple antennas 201. The radio transceiver 210 also includes a receiver 212 that can convert radio signals received by the multiple antennas 201 into baseband signals (received signals) and output the baseband signals to the processor 240.

The network interface 220 is connected to neighboring eNBs 200 via the interfaces X2 (FIG. 1) and connected to MME/S-GWs 300 via the interfaces SI (FIG. 1). The network interface 220 is used in the communication via the interfaces X2 and the communication via the interfaces SI.

The memory 230 can store programs to be executed by the processor 240 and information to be used in the processing performed by the processor 240. The processor 240 includes a signal processor 241 that can perform signal processing such as modulation, demodulation, encoding, and decoding of baseband signals, and a controller 242 that can perform various types of control by executing the programs stored in the memory 230. The processor 240 can perform various types of control, which will be described later.

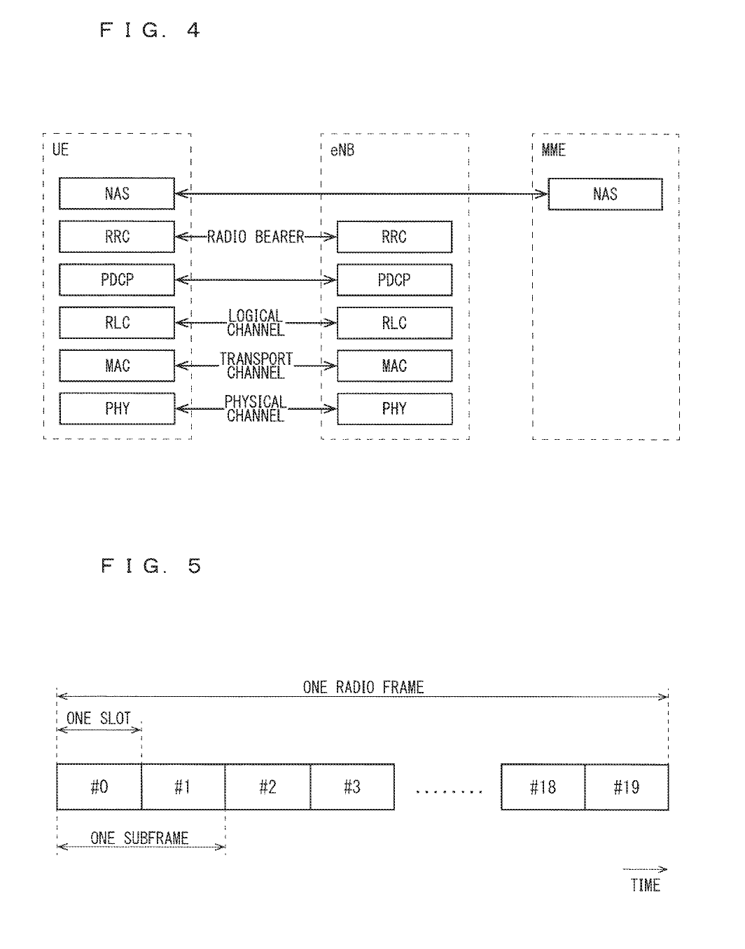

FIG. 4 illustrates a wireless interface protocol stack in the LTE system. As illustrated in FIG. 4, wireless interface protocols are divided into Layers 1 to 3 of the OSI reference model. Layer 1 is a physical (PHY) layer. Layer 2 includes a media access control (MAC) layer, a radio link control (RLC) layer, and a packet data convergence protocol (PDCP) layer. Layer 3 includes a radio resource control (RRC) layer.

The physical layer performs encoding and decoding, modulation and demodulation, antenna mapping and demapping, and resource mapping and demapping. Between the physical layer of a UE 100 and the physical layer of an eNB 200, data is transmitted via a physical channel.

The MAC layer performs processing such as controlling data priority and performing re-transmission processing using hybrid ARQ (HARQ). Between the MAC layer of the UE 100 and the MAC layer of the eNB 200, data is transmitted via a transport channel. The MAC layer of the eNB 200 includes uplink and downlink transport formats (e.g., transport block sizes, and modulation and coding schemes (MCSs)) and a scheduler for determining allocated resource blocks.

The RLC layer transmits data to the RLC layer on the receiving side with use of the functions of the MAC layer and the physical layer. Between the RLC layer of the UE 100 and the RLC layer of the eNB 200, data is transmitted via a logical channel.

The PDCP layer performs header compression and decompression, and encryption and decryption.

The RRC layer is defined in only the control plane. Between the RRC layer of the UE 100 and the RRC layer of the eNB 200, a control message (RRC message) for making various types of settings is transmitted. The RRC layer controls the logic channel, the transport channel, and the physical channel in response to establishment, re-establishment, or release of a radio bearer. When there is an RRC connection between the RRC layer of the UE 100 and the RRC layer of the eNB 200, the UE 100 is in a connected state (RRC connected state), and otherwise the UE 100 is in an idle state (RRC idle state).

A non-access stratum (NAS) layer above the RRC layer performs processing such as session management and mobility management.

FIG. 5 illustrates the structure of a radio frame used in the LTE system. The LTE system applies orthogonal frequency division multiplexing access (OFDMA) to downlink and single carrier frequency division multiple access (SC-FDMA) to uplink.

As illustrated in FIG. 5, the radio frame consists of 10 subframes arranged in the time direction, and each subframe consists of two slots arranged in the time direction. Each subframe has a length of 1 msec, and each slot has a length of 0.5 msec. Each subframe includes multiple resource blocks (RB) in the frequency direction and multiple symbols in the time direction. Each resource block includes multiple subcarriers in the frequency direction. A radio resource unit consisting of a single subcarrier and a single symbol is referred to as a resource element (RE).

Among the radio resources allocated to the UE 100, frequency resources can be identified by resource blocks, and time resources can be identified by subframes (or slots).

In downlink, a section of the first several symbols of each subframe is a control region that is used as physical downlink control channel (PDCCH) for transmitting mainly control signals. The remaining section of the subframe is a region that is used as physical downlink shared channel (PDSCH) for transmitting mainly user data.

The PDCCH conveys control signals. The control signals include, for example, uplink scheduling information (SI), downlink SI, and TPC bits. The uplink SI is information indicating the allocation of uplink radio resources, and the downlink SI is information indicating the allocation of downlink radio resources. The TPC bits are information instructing that uplink transmission power be increased or reduced. These pieces of information are referred to as downlink control information (DCI).

The PDSCH conveys control signals and/or user data. For example, a downlink data region may be allocated to only user data, or may be allocated so that user data and control signals are multiplexed.

In downlink, each subframe is provided with a cell-specific reference signal (CRS) and a channel-state-information reference signal (CSI-RS) that are distributed in the subframe. Each of the CRS and the CSI-RS is configured by a predetermined orthogonal signal series. The eNBs 200 transmit the CRSs and the CSI-RSs from the multiple antennas 201.

In uplink, the opposite ends of each subframe in the frequency direction are control regions used as physical uplink control channel (PUCCH) for transmitting mainly control signals. The central part of the subframe in the frequency direction is a region used as physical uplink shared channel (PUSCH) for transmitting mainly user data.

The PUCCHs convey control signals. The control signals include, for example, a channel quality indicator (CQI), a precoding matrix indicator (PMI), a rank indicator (RI), a scheduling request (SR), and ACK/NACK.

The CQI is an index indicating downlink channel quality and is used to, for example, determine a recommended modulation scheme and a recommended coding rate that are to be used in downlink transmission. The PMI is an index indicating a precoding matrix that is desirably used in downlink transmission. The RI is an index indicating the number of layers (number of streams) available for downlink transmission. The SR is information that requires the allocation of uplink radio resources (resource blocks). The ACK/NACK is information indicating whether signals transmitted via a downlink physical channel (e.g., PDSCH) have been successfully decoded.

The CQI, the PMI, and the RI correspond to the channel state information (CSI) obtained by the UE 100 estimating a channel with use of the downlink reference signals (CRS and/or CSI-RS).

The PUSCH conveys control signals and/or user data. For example, an uplink data region may be allocated to only user data, or may be allocated so that user data and control signals are multiplexed.

In uplink, a predetermined symbol of each subframe is provided with a sounding reference signal (SRS) and a demodulation reference signal (DMRS). Each of the SRS and the DMRS is configured by a predetermined orthogonal signal series.

Embodiments will now be described taking the example of the case where embodiments are applied to the LTE described above with reference to FIGS. 1 to 5.

### Embodiments

A UE 100 feeds back measured channel state information (CSI) to an eNB 200, using a digital transmission system. In one embodiment, the eNB 200 estimates channel quality of an uplink channel that is used in CSI feedback from the UE 100, dynamically adjusts, on the basis of the estimated channel quality, the number of quantized bits to be used when the UE 100 quantizes the CSI and an MCS to be used when the UE 100 transmits the quantized CSI, and notifies the UE 100 of the number of quantized bits and the MCS.

The CSI feedback from the UE 100 is usually implemented using a physical uplink control channel (PUCCH) or a physical uplink shared channel (PUSCH), and therefore the channel quality of these channels are estimated.

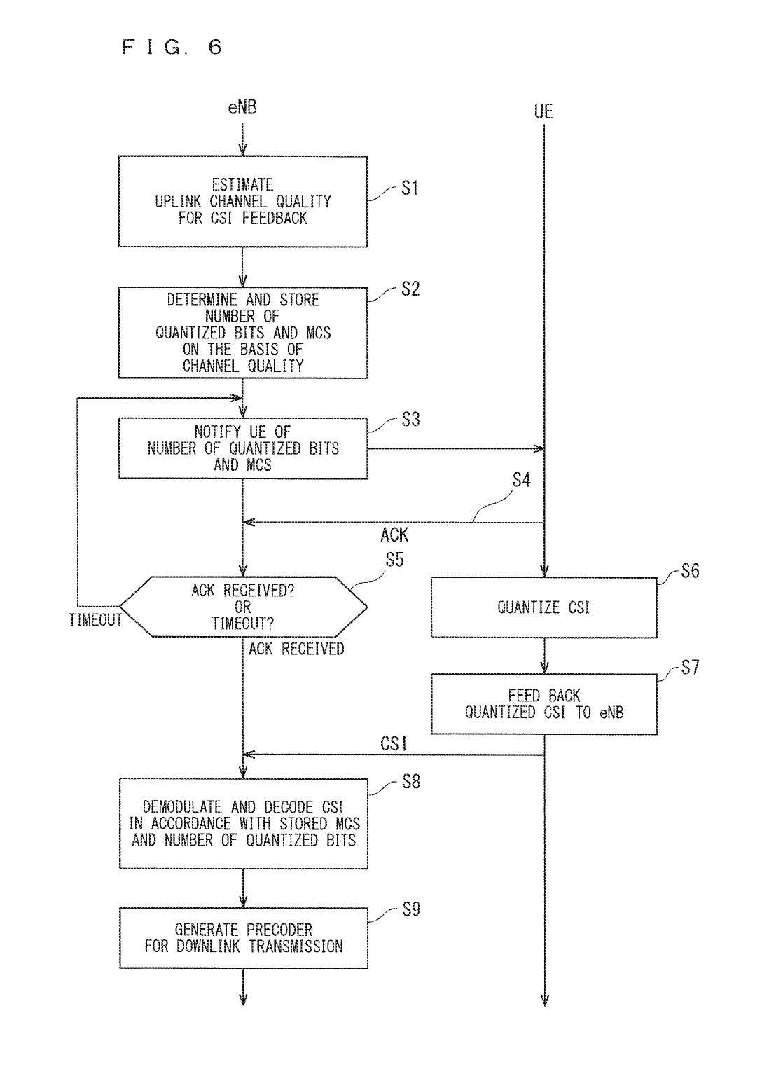

FIG. 6 illustrates a flowchart for describing an operation of controlling dynamic processing of the number of quantized bits and the MCS on the basis of the estimated value of the channel quality according to one embodiment.

As illustrated in FIG. 6, the eNB 200 estimates the channel quality of an uplink channel used in the CSI feedback (step S1).

The channel quality is defined by the signal-to-interference-plus-noise ratio (SINR) or the signal-to-noise ratio (SNR), and the channel quality of the PUCCH and the PUSCH can be estimated using the sounding reference signal (SRS) and/or the demodulation reference signal (DMRS). In the case of the PUCCH, it is also conceivable to estimate the channel quality in an auxiliary manner from the degree of congestion of cells managed by the eNB 200 itself.

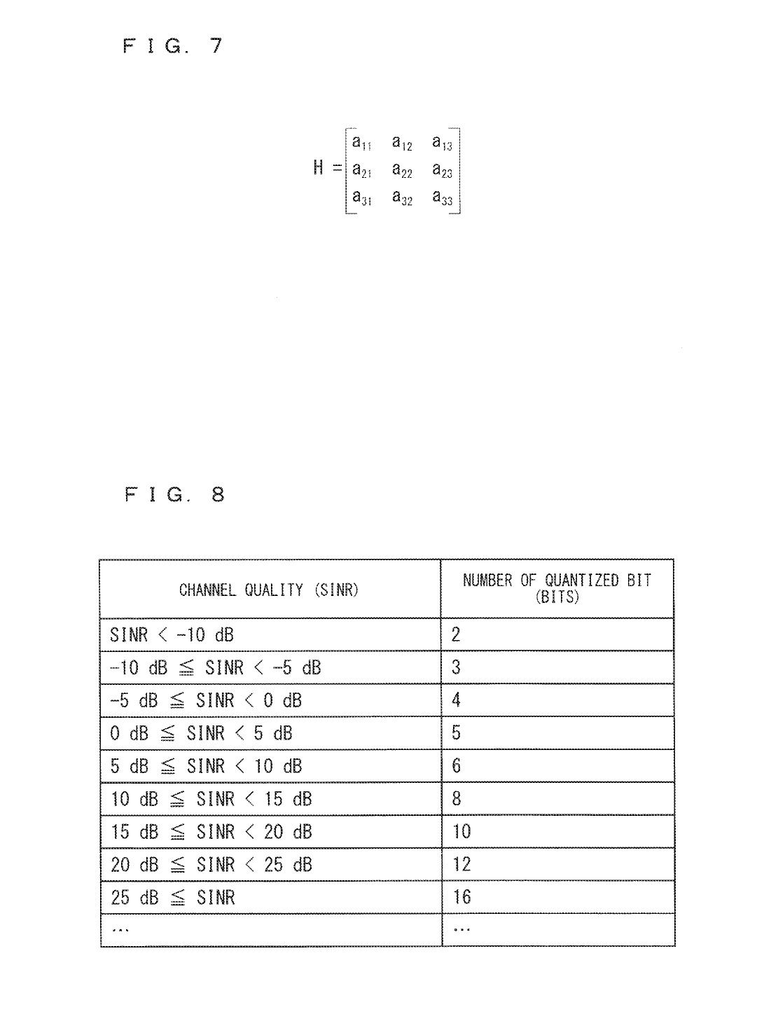

Here, the CSI according to the disclosure is considered to include “source” information such as a channel matrix and a channel covariance matrix, but the disclosure is not limited to this example as long as the effects of the disclosure can be achieved. FIG. 7 illustrates an example of a three-row by three-column channel matrix. Note that elements a₁₁ to a₃₃ in the channel matrix are represented by complex numbers.

Next, the number of quantized bits that is used when the UE 100 quantizes the CSI, and the MCS (modulation and coding scheme) that is used when the UE 100 transmits the quantized CSI are determined on the basis of the estimated channel quality and stored in a predetermined storage, e.g., the memory 230 illustrated in FIG. 3 (step S2).

Here, the number of quantized bits and the MCS, which is used to transmit the quantized CSI, can be readily determined by preparing in advance correspondence tables between the channel quality and the number of quantized bits and between the channel quality and the MCS.

FIG. 8 illustrates an example of the correspondence table between the channel quality and the number of quantized bits, in which the channel quality is defined by the SINR. Referring to FIG. 8, for example if the SINR is less than −10 dB, the number of quantized bits is determined to be two, and if the SINR is greater than or equal to −10 dB and less than −5 dB, the number of quantized bits is determined to be three. In this way, the correspondence table is created such that the number of quantized bits increases as the value of the channel quality (here, the value of the SINR) increases and the channel conditions improves.

This is to quantize the CSI using a small number of bits and reduce the amount of feedback information when the channel quality is low, i.e., when there is a large amount of noise and interference, and to quantize the CSI using a large number of bits and increase the accuracy of the CSI to reduce the number of quantization errors when the channel quality is high, thereby eventually increasing transmission performance.

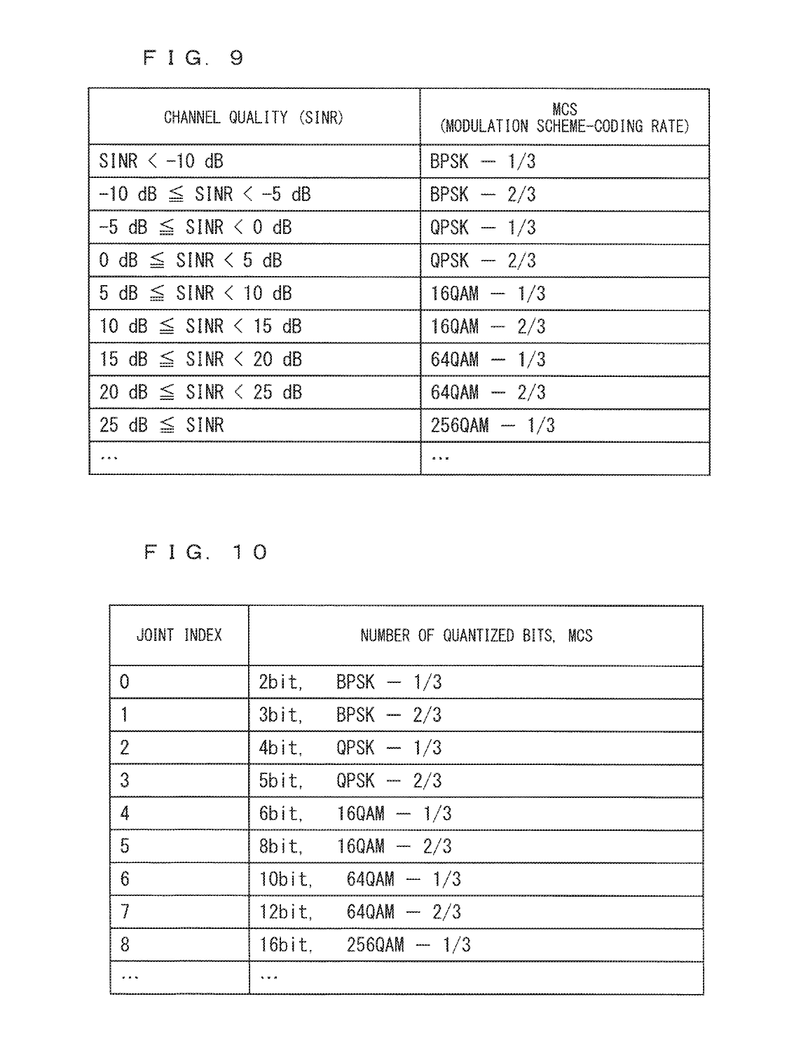

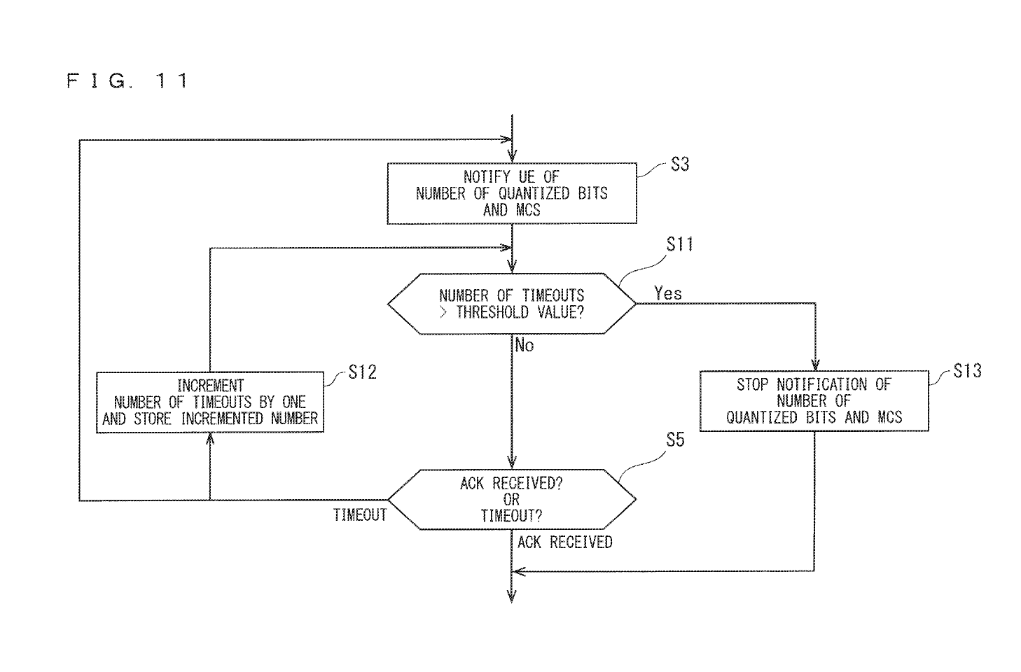

FIG. 9 illustrates an example of the correspondence table between the channel quality and the MCS, in which the channel quality is defined by the SINR. Referring to FIG. 9, for example if the SINR is less than −10 dB, the modulation scheme is determined to be binary phase shift keying (BPSK) and the coding rate is determined to be 1/3, and when the SINR is greater than or equal to −10 dB and less than −5 dB, the modulation scheme is determined to be BPSK and the coding rate is determined to be 2/3. In this way, the correspondence table is created such that the modulation scheme and the coding rate are determined so that more information can be transmitted at once as the value of the channel quality (here, the value of the SINR) increases and the channel conditions improve. The coding rate as used herein refers to a turbo coding rate, and the turbo coding rate is hereinafter simply referred to as the “coding rate.” In the case where a channel coding system other than the turbo coding system is employed, the error-correcting capability of the coding system to be used may be dynamically adjusted. For example, if the SINR is less than −10 dB, the error-correcting capability may be adjusted to be equivalent to that of the turbo coding system with a coding rate of 1/3, and if the SINR is greater than or equal to −10 dB and less than −5 dB, the error-correcting capability may be adjusted to be equivalent to that of the turbo coding system with a coding rate of 2/3.

This is for the following reason: when the channel quality is low, the CSI is quantized using a small number of bits and thus the overhead decreases, in which case the modulation scheme and the coding rate are not required to have the capability of transmitting a large amount of information at once, whereas when the channel quality is high, the CSI is quantized using a large number of bits and thus the overhead increases, in which case the modulation scheme and the coding rate are required to have the capability of transmitting a large amount of information at once.

FIG. 9 illustrates an example in which the modulation scheme changes from BPSK to quadrature phase shift keying (QPSK) and then from QPSK to quadrature amplitude modulation (QAM) as the channel quality improves, and the form of QAM also changes from 16QAM to 64QAM and to 256QAM as the channel quality improves. Note that the correspondence tables illustrated in FIGS. 8 and 9 are merely one example, and the disclosure is not limited to this example.

Returning to the description of FIG. 6, after the number of quantized bits and the MCS, which is used when transmitting the quantized CSI, have been determined, the determined number of quantized bits and the determined MCS are read out from the predetermined storage and given as a notification to the UE 100 (step S3).

In this case, each of the determined number of quantized bits and the determined MCS may be given as a notification to the UE 100, but in the case of using, for example, the correspondence tables between the channel quality and the number of quantized bits and between the channel quality and the MCS as illustrated in FIGS. 8 and 9, 4-bit data is necessary to notify the UE of the number of quantized bits and another 4-bit data is necessary to notify the UE of the MCS. That is, a total of 8-bit data needs to be transmitted, resulting in an increase in overhead.

In view of this, a technique is conceivable in which patterns of combinations of the number of quantized bits and the MCS are set in advance, an index (referred to as a “joint index”) are allocated to each combination, and a correspondence table (referred to as a “joint table”) between the index and the combination of the number of quantized bits and the MCS is stored in the UE 100 in advance. Then, after the number of quantized bits and the MCS has been determined, the eNB 200 notifies the UE 100 of information regarding the joint index that corresponds to the combination of the number of quantized bits and the MCS. This reduces the overhead.

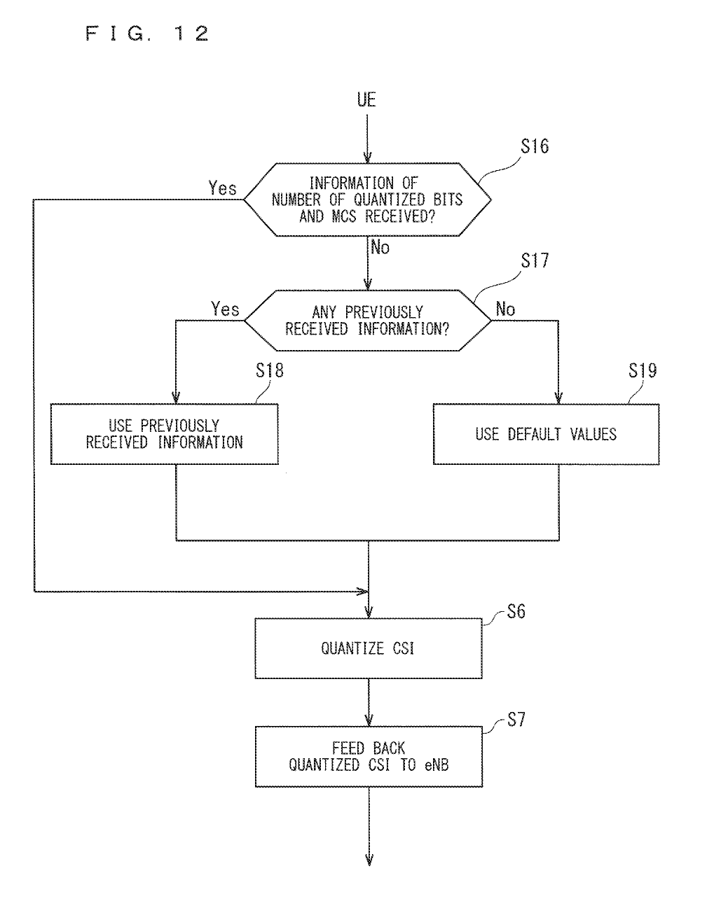

FIG. 10 illustrates an example of the joint table in which, for example, joint index 0 corresponds to a combination of 2 bits as the number of quantized bits, BPSK as the modulation scheme, and ⅓ as the coding rate.

The UE 100 references the joint table on the basis of the received index number and acquires the number of quantized bits and the MCS that correspond to the index number.

During one communication session, after the initial notification of the index has been given to the UE 100, the next notification may include only information regarding a difference from the previous index.

For example, the notification may take such a form that when 1-bit information indicates “0,” the index is set to one level lower than the previous index, and when the 1-bit information indicates “1,” the index is set to one level higher than the previous index. If the amount of information is increased to 2 bits, the index may be set to two levels lower than or higher than the previous index.

Note that the transmission of the information regarding the number of quantized bits and the MCS (or the joint index) to the UE 100 may use signaling such as downlink control information (DCI) signaling, MAC control element (MCE) signaling, or radio resource control (RRC) signaling.

Referring back to the description with reference to FIG. 6, the UE 100 that has received the information regarding the number of quantized bits and the MCS (or the joint index) transmits an acknowledge (ACK) signal to the eNB 200 (step S4).

After notifying the UE 100 of the information regarding the number of quantized bits and the MCS (or the joint index), the eNB 200 waits for receipt of the ACK signal for a predetermined period of time (step S5). If the ACK signal has been received within the predetermined period of time, the procedure proceeds to step S8, and if the ACK signal has not been received within the predetermined period of time, a timeout occurs and the notification is again given to the UE 100 in step S3.

Meanwhile, the UE 100 that has transmitted the ACK signal quantizes the CSI on the basis of the information regarding the number of quantized bits received from the eNB 200 (step S6), and feeds back the quantized CSI to the eNB 200, using the modulation scheme and the coding rate of the MCS (step S7).

In step S8, the eNB 200 that has received the quantized CSI demodulates and decodes the CSI in accordance with the number of quantized bits and the MCS that are stored in the predetermined storage (that are given as a notification to the UE 100). Note that the number of quantized bits and the MCS that are stored in the eNB 200 and the number of quantized bits and the MCS that are received by the UE 100 are all reset (cleared) at the end of the communication session.

Then, a precoder for downlink transmission is generated on the basis of the fed-back CSI (step S9).

As described above, the eNB 200 estimates the channel quality of an uplink channel used in the CSI feedback from the UE 100, dynamically adjusts, on the basis of the estimated channel quality, the number of quantized bits to be used when the UE 100 quantizes the CSI and the MCS to be used when the UE 100 transmits the quantized CSI, and notifies the UE 100 of the number of quantized bits and the MCS. With this configuration, the accuracy of the CSI that is fed back from the UE 100 improves in good channel conditions, and accordingly an improvement in transmission performance can be expected.

While the above description is given on the assumption that the eNB 200 estimates the channel quality of the uplink channel used in the CSI feedback from the UE 100 and dynamically adjusts, on the basis of the estimated channel quality, the number of quantized bits to be used when the UE 100 quantizes the CSI and the MCS to be used when the UE 100 transmits the quantized CSI, a configuration is also possible in which only the number of quantized bits is dynamically adjusted, and the MCS may be a modulation coding scheme (e.g., QPSK-1/3) that is set by default, or may be an existing MCS mechanism (e.g., CSI feedback using the PUSCH).

Note that the operation of controlling the dynamic processing of the number of quantized bits and the MCS on the basis of the estimated value of the channel quality, which is described with reference to FIG. 6, is performed by the controller 242 of the processor 240 of the eNB 200.

Variation 1

The above description of the dynamic processing of the number of quantized bits and the MCS with reference to FIG. 6 takes the example of the case where if the ACK signal is not received in step S5, a timeout occurs repeatedly and there is no limit to the number of timeouts. Alternatively, a configuration is also possible in which a threshold value is set for the number of timeouts, and if the number of timeouts exceeds the threshold value, the transmission of the notification of the number of quantized bits and the MCS (or the joint index) is stopped.

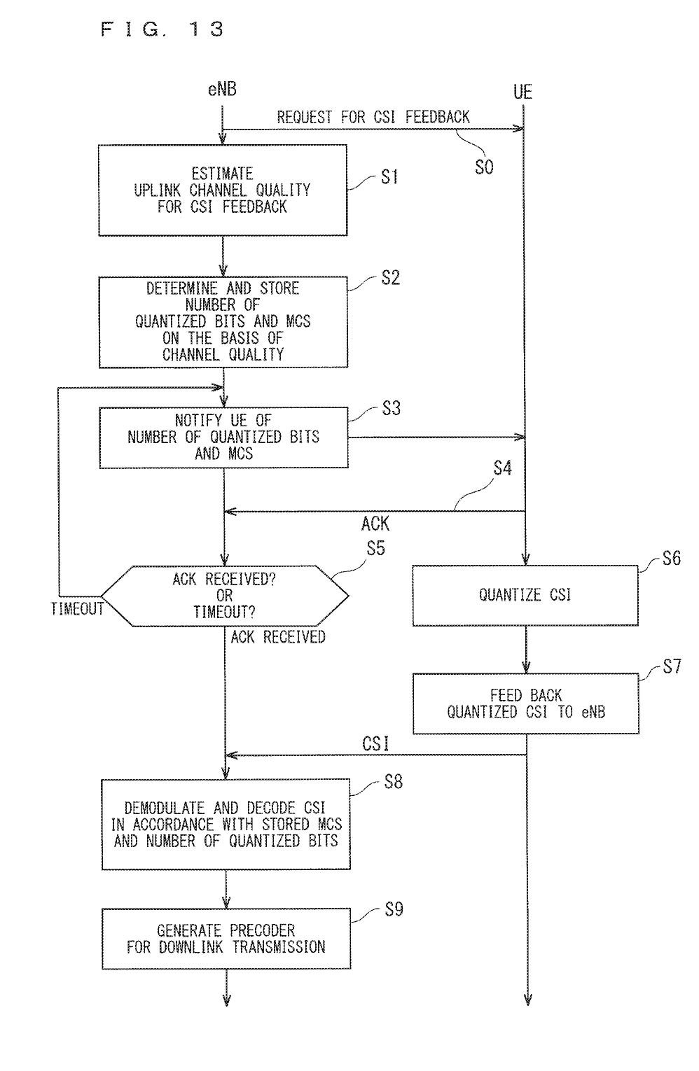

More specifically, steps S11, S12, and S13 illustrated in FIG. 11 may be added between steps S3 and S5 in the flowchart illustrated in FIG. 6.

As illustrated in FIG. 11, after the UE 100 is notified of the number of quantized bits and the MCS in step S3, whether the number of timeouts exceeds the threshold value is determined (step S11).

If the number of timeouts is less than the threshold value, the eNB 200 waits for receipt of the ACK signal from the UE 100 for the predetermined period of time (step S5).

If the ACK signal was not received within the predetermined period of time, a timeout occurs, and the eNB 200 gives the notification again to the UE 100 in step S3, increments the count of the number of timeouts by one, and waits for the determination in step S11 (step S12).

On the other hand, if it is determined in step S11 that the number of timeouts exceeds the threshold value, the eNB 200 stops giving the notification of the number of quantized bits and the MCS (step S13).

With this configuration, it is possible to prevent the operation of giving a notification of the number of quantized bits and the MCS from being repeated without limitation when the ACK signal is not received from the UE 100. Note that the count of the number of timeouts is reset at the end of the communication session.

When the eNB 200 employs the above configuration, there are cases where the UE 100 cannot receive information regarding the number of quantized bits and the MCS. In such cases, the UE 100 may be configured to use previously received information regarding the number of quantized bits and the MCS, if there is any, or if there is no previously received information regarding the number of quantized bits and the MCS (the information was not received once during the current session), use a default number of quantized bits (e.g., 4 bits) to quantize the CSI, and use a default MCS (e.g., QPSK-1/3) to feed back the quantized CSI to the eNB.

More specifically, steps S16 to S19 illustrated in FIG. 12 may be added to steps S6 and S7 in the flowchart illustrated in FIG. 6.

As illustrated in FIG. 12, the UE 100 determines whether the information regarding the number of quantized bits and the MCS has been received (step S16), and if the information regarding the number of quantized bits and the MCS has been received, quantizes the CSI on the basis of the information regarding the number of quantized bits (step S6) and feeds back the quantized CSI to the eNB 200, using the modulation scheme and the coding rate of the MCS (step S7).

On the other hand, if it is determined in step S16 that the information regarding the number of quantized bits and the MCS has not been received, the presence or absence of previously received information regarding the number of quantized bits and the MCS is determined in step S17.

If there is previously received information regarding the number of quantized bits and the MCS, the previously received information regarding the number of quantized bits and the MCS is read out and used (step S18). On the other hand, if it is determined in step S17 that there is no previously received information regarding the number of quantized bits and the MCS (the information was not received once during the current session), default information regarding the number of quantized bits and the MCS is read out and used (step S19).

Then, in step S6, the previously received number of quantized bits or the default number of quantized bits is used to quantize the CSI, and in step S7, the previously received MCS or the default MCS is used to feed back the quantized CSI to the eNB 200. In the case where the UE 100 uses the previously received values or the default values as described above, the eNB 200 may not be able to demodulate and decode the quantized CSI. This is because the CSI may have been processed using the number of quantized bits and an MCS that are different from those transmitted from the UE 100.

In this case, the eNB 200 attempts to demodulate and decode the CSI, using the number of quantized bits and the MCS that the eNB 200 has previously transmitted to the UE 100, and if the attempt ends in failure, uses the default number of quantized bits and the default MCS to demodulate and decode the CSI.

Note that in the case of using such default or previous values as described above, the UE 100 may notify the eNB 200 of the use of such values. This shortens the time that the eNB 200 will spend in attempting demodulation and decoding of the CSI.

Variation 2

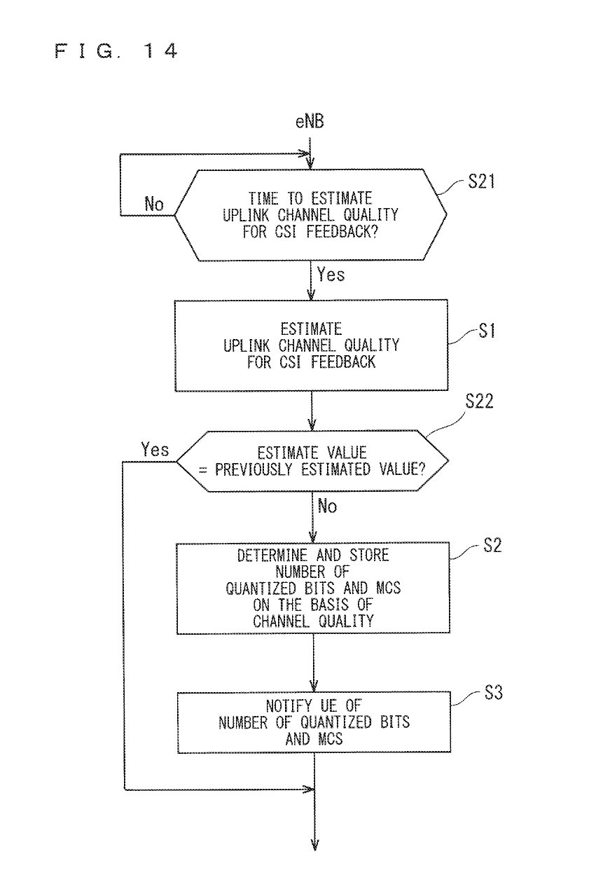

The LTE standards define cases where the CSI feedback from a UE 100 is periodic and where the CSI feedback from a UE 100 is non-periodic. The dynamic processing of the number of quantized bits and the MCS described with reference to FIG. 6 can be applied to both of the periodic CSI feedback and the no-periodic CSI feedback if the dynamic processing is performed at every timing of the CSI feedback. To clarify this, the non-periodic CSI feedback will be described with reference to FIG. 13.

As illustrated in FIG. 13, the eNB 200 requests the UE 100 to feed back the CSI (step S0) before estimating the channel quality of the uplink channel used in the CSI feedback in step S1. Note that the request for CSI feedback may be made after the estimation of the channel quality. The processing performed in steps S1 to S9 is the same as that in FIG. 6 and thus descriptions thereof will be omitted.

Variation 3

The cycle of estimation of the channel quality may be longer than the cycle of CSI feedback. In this case, the number of quantized bits and the MCS may be dynamically adjusted in proper cycles or as necessary (e.g., when the channel quality has changed) every time the channel quality is estimated.

Under circumstances in which the rate at which the channel quality varies (the rate of change within a fixed period of time) is sufficiently slower than the cycle of CSI feedback, adopting the above-described configuration reduces the processing load involved in the estimation of the channel quality and reduces the overhead involved in the notification of the number of quantized bits and the MCS.

Variation 4

The estimation of the channel quality and the notification of the number of quantized bits and the MCS may be conducted periodically at fixed intervals, irrespective of the cycle of CSI feedback.

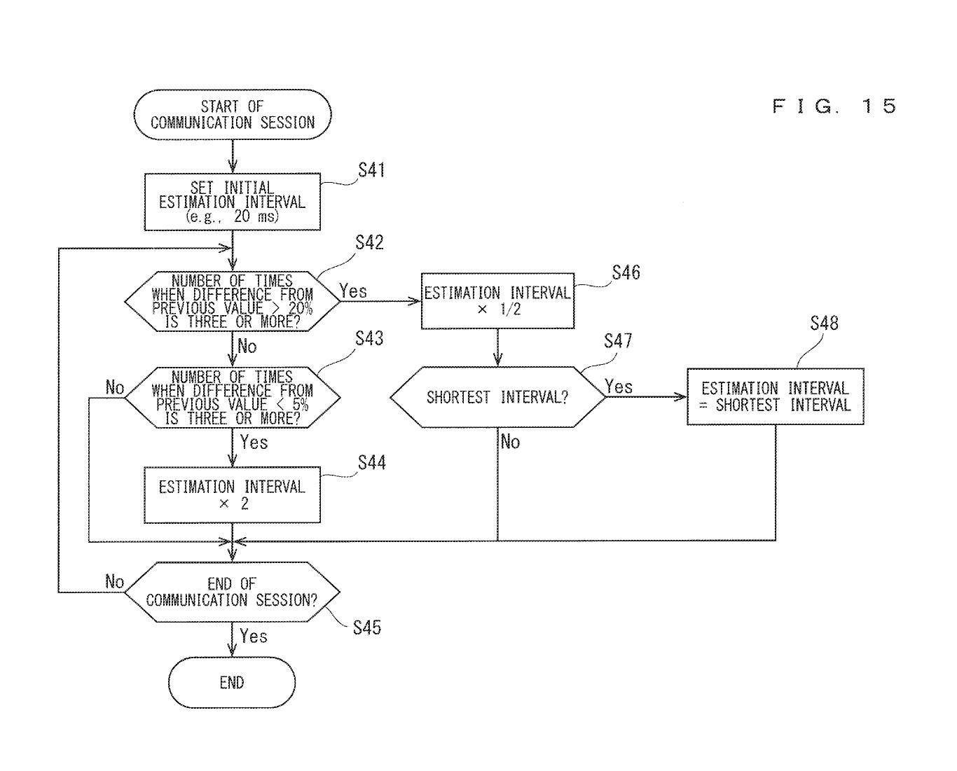

More specifically, steps S21 and S22 illustrated in FIG. 14 may be added to steps S1 to S3 in the flowchart illustrated in FIG. 6.

As illustrated in FIG. 14, prior to step S1, the eNB 200 determines whether it is time to estimate the channel quality of the uplink channel used in the CSI feedback (step S21).

If it is time for estimation, the eNB 200 performs the processing in step S1, and otherwise the eNB 200 stands by.

After the channel quality has been estimated in step S1, whether the estimated value is the same as the previously estimated value is determined (step S22).

If it is determined in step S22 that the estimated value is not the same as the previously estimated value, the eNB 200 performs the processing in step S2 and notifies the UE 100 of the number of quantized bits and the MCS (step S3). In this case, the latest estimated value is stored for use in comparison at the next estimation time.

On the other hand, if it is determined in step S22 that the estimated value is the same as the previously estimated value, the notification of the number of quantized bits and the MCS is not transmitted, and the latest estimated value is not stored. That is, the previously estimated value to be compared with is not updated. Although the UE 100 cannot receive the notification of the number of quantized bits and the MCS in this case, the UE 100 may adopt the configuration described above with reference to FIG. 12 so that the UE 100 is able to quantize the CSI and to feed back the quantized CSI to the eNB 200 by using either the number of quantized bits to be used when quantizing the previous CSI or, if the information regarding such as the number of quantized bits was not received once, a default number of quantized bits.

Here, the determination of step S22 as to whether the estimated value is the same as the previous estimated value may be implemented by, for example, setting a threshold value (e.g., the estimated value is determined the same when a difference from the previous estimated value is within a range of 5%). Note that the threshold value is not limited to 5% and may be set to other values such as 3% or 10%.

The time interval of estimating the channel quality is set to, for example, a default value of 20 msec, but the disclosure is not limited to this value. For UEs that show rapid changes, the time interval may be set to, for example, 10 msec, 5 msec, or 2 msec.

With this configuration, it is possible to cope with various channel conditions that change with time. Note that the stored estimated value of the channel quality is reset at the end of the communication session.

If the eNB 200 notifies the UE 100 of the number of quantized bits and the MCS periodically at fixed time intervals and if it is determined in step S22 that the estimated value is the same as the previous estimated value, the notification of the number of quantized bits and the MCS is not transmitted. Thus there are cases where the UE 100 is unable to receive information regarding the number of quantized bits and the MCS. In this case, the UE 100 may be configured to use previously received information regarding the number of quantized bits and the MCS, and if there is no previously received information regarding the number of quantized bits and the MCS, use a default number of quantized bits (e.g., 4 bits) to quantize the CSI and a default MCS (e.g., QPSK-1/3) to feed back the quantized CSI to the eNB. The specific configuration thereof is the same as that illustrated in FIG. 12, and thus descriptions thereof will be omitted.

As another alternative, the time interval of estimating the channel quality may be dynamically adjusted in accordance with the rate of change of the channel quality as described below.

FIG. 15 illustrates a flowchart for describing a method of dynamically adjusting the time interval of channel estimation. As illustrated in FIG. 15, when a communication session between an eNB 200 and a UE 100 is started, the initial estimation interval is set to, for example, 20 msec (step S41).

Then, the channel estimation is repeated at an interval of 20 msec, and whenever the channel estimation is conducted, the difference between the new estimated value and the previous estimated value is calculated and it is determined whether the difference between the new estimated value and the previous estimated value exceeds 20% (step S42). Then, if the number of cases where the difference exceeds 20% reaches three or more within a predetermined period of time, the procedure proceeds to step S46, and otherwise the procedure proceeds to step S43.

Here, the case in which the number of cases where the difference exceeds 20% reaches three or more within a predetermined period of time indicates the case where a cumulative total of the number of cases where the difference exceeds 20% reaches three or more within a period of time corresponds to, for example, five times the currently set estimation interval (i.e., within a period of time required to conduct the estimation five times). When the estimation interval is, for example, the initial set value of 20 msec, the number of cases where the difference exceeds 20% reaches three or more within a period of time that corresponds to five times the initial estimation interval (100 msec).

If the procedure proceeds to step S46, i.e., if the number of cases where the difference exceeds 20% reaches three or more within the predetermine period of time, it can be said that the channel quality greatly changes at frequent intervals, and therefore the estimation interval is halved to check the rate of change of the channel quality.

The procedure then proceeds to step S47, in which it is determined whether the changed estimation interval is shorter than a shortest interval. If it is determined that the changed estimation interval is shorter than the shortest interval, the estimation interval is set to the shortest interval (step S48), and the procedure proceeds to step S45. The shortest interval as used herein refers to the shortest time interval of CSI feedback provided by the LTE specification. For example, when the shortest duration of CSI feedback is one subframe, the shortest estimation interval is 1 msec.

On the other hand, if it is determined that the changed estimation interval is longer than or equal to the shortest interval, the changed estimation interval remains unchanged and the procedure proceeds to step S45.

If the procedure proceeds from step S42 to step S43, i.e., if the number of cases where the difference exceeds 20% does not reach three within the predetermined period of time, it is determined in step S43 whether the number of cases where the difference between the new estimated value and the previous estimated value is less than 5% reaches three or more within a predetermined period of time. This is the operation of confirming that the channel quality does not change very much, rather than changing greatly so that the difference between the new estimated value and the estimated value exceeds 20%.

The predetermined period of time as used herein is the same as the predetermined period of time used in the case of determining whether the difference exceeds 20%. That is, two determinations as to whether the difference between the new estimated value and the previous estimated value exceeds 20% and whether the difference is less than 5% are made within the same predetermined period of time.

If the number of cases where the difference is less than 5% reaches three or more within the predetermined period of time, the procedure proceeds to step S44, and otherwise the procedure proceeds to step S45.

If the procedure proceeds to step S44, i.e., if the number of cases where the difference is less than 5% reaches three or more within the predetermined period of time, it can be said that the channel quality does not change at frequent intervals, and thus there is no need to frequency check whether the channel quality has changed. Accordingly, the estimation interval is doubled, and the procedure proceeds to step S45.

In step S45, it is determined whether the current proceeding communication session has ended. If the communication session has ended, the control of the dynamic adjustment of the channel estimation interval also ends. On the other hand, if the communication session has not yet ended, the processing of step S42 onward is repeated. If the communication session has ended, the estimated value of the channel quality and the counted number are reset.

If the procedure proceeds from step S42 to step S43 and then from step S43 to step S45, i.e., if the estimation interval has not been changed within the predetermined period of time, a value that corresponds to the oldest estimated value is discarded from the count value of the number of times recorded, and a value that corresponds to a new estimated value obtained after the elapse of the estimation interval is counted. Alternatively, all of the count values (e.g., five) of the number of times recorded may be discarded to reset the recording, and the number of times may be recorded again within the predetermined period of time.

If step S44 or S46 is performed, i.e., if the estimation interval has been changed within the predetermined period of time (including the case where step S48 is performed as a result of the determination in step S47), the count value of the number of times recorded is reset, and the number of times is recorded again within the predetermined period of time.

The aforementioned difference (e.g., 20% or 5%) between the new estimated value and the previous estimated value is merely one example, and it goes without saying that the difference may be changed from 20% to 15% or from 5% to 3%, for example.

The number of times (three) that the difference between the new estimated value and the previous estimated value exceeds or becomes less than the predetermined value within the predetermined period of time is merely one example, and it goes without saying that the number of times may be set to other values such as two or five.

The operation of dynamically adjusting the channel estimation interval described with reference to FIG. 15 is performed by the controller 242 of the processor 240 of the eNB 200.

While the above has been a detailed description of the disclosure, the above description is illustrative in all aspects and is not intended to limit the disclosure. Numerous modifications and variations that are not illustrated are conceivable without departing from the scope of the disclosure.

Note that embodiments of the disclosure may be appropriately modified or omitted within the scope of the disclosure.

1. A wireless communication device for performing communication with a controlled wireless communication device that is controlled by the wireless communication device, comprising:
at least one processor configured to estimate channel quality of a channel that is used in feedback of a signal from the controlled wireless communication device, dynamically adjust, on the basis of the estimated channel quality, the number of quantized bits that is used when the controlled wireless communication device quantizes channel state information, and notify the controlled wireless communication device of the dynamically adjusted number of quantized bits,
the at least one processor being configured to increase the number of quantized bits as the estimated channel quality improves.

2. The wireless communication device according to claim 1, wherein
the at least one processor is configured to dynamically adjust, in accordance with the dynamic adjustment of the number of quantized bits, a modulation scheme and a coding rate that are to be used when the controlled wireless communication device transmits quantized channel state information.

3. The wireless communication device according to claim 1, wherein
the at least one processor is configured to:
set numerical ranges of the channel quality in levels and associate the number of quantized bits with each of the numerical ranges; and
in a case where the estimated channel quality is within one of the numerical ranges, determine the number of quantized bits that is associated with the one numerical range as the number of quantized bits that corresponds to the estimated channel quality, and notify the controlled wireless communication device of information regarding the determined number of quantized bits.

4. The wireless communication device according to claim 2, wherein
the at least one processor is configured to:
set numerical ranges of the channel quality in levels and associate the modulation scheme and the coding rate with each of the numerical ranges; and
in a case where the estimated channel quality is within one of the numerical ranges, determine the modulation scheme and the coding rate that are associated with the one numerical range as a modulation scheme and a coding rate that correspond to the estimated channel quality, and notify the controlled wireless communication device of information regarding the determined modulation scheme and the determined coding rate.

5. The wireless communication device according to claim 2, wherein
the at least one processor is configured to:
set numerical ranges of the channel quality in levels, associate the number of quantized bits, the modulation scheme, and the coding rate with each of the numerical ranges, and allocate an index to each of the numerical ranges of the channel quality; and
in a case where the estimated channel quality is within one of the numerical ranges, determine the number of quantized bits, the modulation scheme, and the coding rate that are associated with the one numerical range as the number of quantized bits, a modulation scheme, and a coding rate that correspond to the estimated channel quality, and notify the controlled wireless communication device of information regarding the allocated index.

6. The wireless communication device according to claim 1, wherein
the at least one processor is configured to, in a case where an acknowledge signal is not received from the controlled wireless communication device within a predetermined period of time after the dynamically adjusted number of quantized bits is transmitted to the controlled wireless communication device, repeat an operation of notifying the controlled wireless communication device of the dynamically adjusted number of quantized bits, and when the number of repetitions exceeds a predetermined value, stop the operation of notifying the controlled wireless communication device of the dynamically adjusted number of quantized bits.

7. The wireless communication device according to claim 1, wherein
the at least one processor is configured to dynamically adjust an estimation interval for estimating the channel quality, in accordance with a rate of change of the channel quality.

8. A wireless communication system comprising:
a wireless communication device; and
a controlled wireless communication device that is under control of the wireless communication device,
the wireless communication device including at least one processor configured to estimate channel quality of a channel that is used in feedback of a signal from the controlled wireless communication device, dynamically adjust, on the basis of the estimated channel quality, the number of quantized bits to be used when the controlled wireless communication device quantizes channel state information, and notify the controlled wireless communication device of the dynamically adjusted number of quantized bits, and
the at least one processor being configured to increase the number of quantized bits as the estimated channel quality improves.

9. The wireless communication system according to claim 8, wherein
the controlled wireless communication device is configured to, in a case where information regarding the number of quantized bits is not received from the wireless communication device, use previously received information regarding the number of quantized bits or default information regarding the number of quantized bits to quantize the channel state information.

10. The wireless communication system according to claim 9, wherein
the at least one processor is configured to dynamically adjust, in accordance with the dynamic adjustment of the number of quantized bits, a modulation scheme and a coding rate that are to be used when the controlled wireless communication device transmits quantized channel state information, and notify the controlled wireless communication device of the dynamically adjusted modulation scheme and the dynamically adjusted coding rate, and
the controlled wireless communication device is configured to, in a case where information regarding the modulation scheme and the coding rate is not received from the wireless communication device, use previously received information regarding the modulation scheme and the coding rate or default information regarding the modulation scheme and the coding rate to transmit the quantized channel state information.

11. A communication control method for use in a wireless communication device for performing communication with a controlled wireless communication device that is under control of the wireless communication device, the method comprising the steps of:
(a) estimating channel quality of a channel that is used in feedback of a signal from the controlled wireless communication device; and
(b) dynamically adjusting, on the basis of the estimated channel quality, the number of quantized bits to be used when the controlled wireless communication device quantizes channel state information,
the step (b) including the step of adjusting the number of quantized bits such that the number of quantized bits increases as the estimated channel quality improves.
